(19) United States
(12) Patent Application Publication
(10) Pub. No.: US 2019/0346307 A1
(43) Pub. Date: Nov. 14, 2019

(54) SPECTRAL IMAGING SYSTEMS AND METHODS OF GENERATING SPECTRAL IMAGE DATA USING THE SAME

(71) Applicant: Corning Incorporated, Corning, NY (US)

(72) Inventors: Michael Lucien Genier, Horseheads, NY (US); Jeffry John Santman, Keene, NH (US); Patrick Wallace Woodman, Marlborough, NH (US)

(21) Appl. No.: 16/461,524

(22) PCT Filed: Nov. 20, 2017
(86) PCT No.: PCT/US2017/062506

§ 371 Date: May 16, 2019

Related U.S. Application Data
(60) Provisional application No. 62/428,032, filed on Nov. 30, 2016.

(51) Int. Cl. G01J 3/28; G01J 3/02; H04N 5/355; H04N 5/345

(52) U.S. Cl. CPC G01J 3/2823; G01J 3/2803; G01J 2003/1213; H04N 5/35563; H04N 5/345; G01J 3/0213

(57) ABSTRACT

A spectral imaging system includes a a focal plane array (122). The focal plane array includes a plurality of imaging pixel rows (124), each imaging pixel row of the plurality of imaging pixel rows includes two or more individual imaging pixels, and the plurality of imaging pixel rows include a first imaging pixel row (124a) and a second imaging pixel row (124b). The spectral imager also includes a reference filter (142) optically coupled to the first imaging pixel row of the focal plane array and a multivariate optical element (140) optically coupled to the second imaging pixel row of the focal plane array.

This application claims the benefit of priority under 35 U.S.C. § 119 of U.S. Provisional Application Ser. No. 62/428,032 filed on Nov. 30, 2016, the content of which is relied upon and incorporated herein by reference in its entirety.

### BACKGROUND

### Field

The present specification generally relates to systems and methods for spectral imaging, and more particularly, spectral imaging systems including a plurality of pixels, a reference filter, and a multivariate optical element.

### Technical Background

Commercial and industrial applications for hyper-spectral imaging are an expansive, emerging market, particularly in the area of in-line process monitoring. However, conventional hyper-spectral imaging equipment is often too expensive and too slow at integration to be implemented for many applications, particularly when the application requires detection in the Short-Wave InfraRed (SWIR) spectral region. High-speed SWIR cameras are commercially available, but are very expensive and usually require additional processing hardware to handle the large volumes of data being generated at very high rates. Further, the complex optical components, such as optical filters, also add to the cost and complexity of the system.

From process development and cost perspectives there are many opportunities for improvement in hyper-spectral imaging systems. It is of great interest to have a faster, simpler, cheaper, and more precise system of spectrally imaging and analyzing specimen samples than what is currently practiced in the market. Accordingly, a need exists for alternative improved systems and methods of spectral imaging.

### SUMMARY

According to one embodiment, a spectral imaging system includes a focal plane array. The focal plane array includes a plurality of imaging pixel rows, each imaging pixel row of the plurality of imaging pixel rows includes two or more individual imaging pixels and the plurality of imaging pixel rows include a first imaging pixel row and a second imaging pixel row. The spectral imager also includes a reference filter optically coupled to the first imaging pixel row of the focal plane array and a multivariate optical element optically coupled to the second imaging pixel row of the focal plane array.

In another embodiment, a method includes generating a reference signal regarding a first portion of the specimen sample using a spectral imaging system. The spectral imaging system includes a plurality of imaging pixels having a first imaging pixel and a second imaging pixel, a reference filter optically coupled to the first imaging pixel, and a multivariate optical element optically coupled to the second imaging pixel. The first portion of the specimen sample is optically aligned with the first imaging pixel such that light traverses the reference filter before irradiating the first imaging pixel, thereby generating the reference signal. The method further includes optically aligning the first portion of the specimen sample with the second imaging pixel such that light traverses the multivariate optical element before irradiating the second imaging pixel and generating a spectral signal upon irradiation of light onto the second imaging pixel.

In yet another embodiment, a spectral imaging system includes an aperture, a plurality of imaging pixels having a first imaging pixel and a second imaging pixel, and imaging optics positioned between and optically coupled to the aperture and the plurality of imaging pixels. The imaging optics are configured to direct light from the aperture onto one or more of the plurality of imaging pixels. The spectral imager also includes a reference filter optically coupled to the first imaging pixel and positioned between the imaging optics and the first imaging pixel and a multivariate optical element optically coupled to the second imaging pixel and positioned between the imaging optics and the second imaging pixel.

Additional features and advantages of the processes and systems described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1A schematically depicts a spectral imaging system comprising a spectral imager, a specimen sample and an imaging pathway extending therebetween, according to one or more embodiments shown and described herein;

FIG. 1B schematically depicts the spectral imaging system of FIG. 1A, wherein the specimen sample is positioned in a different location relative to the spectral imager than depicted in FIG. 1A, according to one or more embodiments shown and described herein;

FIG. 1C schematically depicts external imaging optics of the spectral imaging system of FIGS. 1A and 1B, according to one or more embodiments shown and described herein;

FIG. 2 schematically depicts a spectral imager having a plurality of imaging pixels arranged in a focal plane array, according to one or more embodiments shown and described herein;

FIG. 3A schematically depicts the spectral imager of FIG. 2 having a reference filter and a multivariate optical element optically coupled to individual rows of the plurality of imaging pixels, according to one or more embodiments shown and described herein;

FIG. 3B schematically depicts the spectral imager of FIG. 2 having a reference filter and multiple multivariate optical elements optically coupled to individual rows of the plurality of imaging pixels, according to one or more embodiments shown and described herein;

FIG. 3C schematically depicts the spectral imager of FIG. 2 having multiple reference filters and multiple multivariate optical elements optically coupled to individual rows of the plurality of imaging pixels, according to one or more embodiments shown and described herein; and

FIG. 4 schematically depicts a spectral imager comprising a housing, an aperture and a plurality of imaging pixels, according to one or more embodiments shown and described herein.

### DETAILED DESCRIPTION

Reference will now be made in detail to embodiments of spectral imaging systems and methods of generating spectral signals and spectral image data, examples of which are illustrated in the accompanying drawings. Whenever possible, the same reference numerals will be used throughout the drawings to refer to the same or like parts. A spectral imaging system includes a spectral imager having a plurality of imaging pixels, such as a focal plane array of imaging pixels. The plurality of imaging pixels are each configured to receive and output a signal based on light reflected off a specimen sample and received by the plurality of imaging pixels. The spectral imaging system also includes an imaging controller communicatively coupled to the plurality of imaging pixels. The imaging controller generates image data regarding the specimen sample based on the signals output by the plurality of imaging pixels. A reference filter and a multivariate optical element are optically coupled to the plurality of imaging pixels and operate to alter the specimen-reflected light received by the plurality of imaging pixels such that the signals output by the plurality of imaging pixels allow the imaging controller to generate spectral image data and localize a target spectral signature of the specimen sample. In operation, the spectral imaging system described herein generates image data at faster processing speeds than previous imaging systems because the imaging controller generates image data based only on a subset of the imaging pixels, for example, the imaging pixels optically coupled to the reference filter and the multivariate optical element. Further, some embodiments of the spectral imaging systems described herein do not require a filter change mechanism to exchange between the multivariate optical element and the reference filter, as each are coupled to different imaging pixels, reducing complexity and cost. The spectral imaging system and methods of analyzing a specimen sample using the spectral imaging system will be described in more detail herein with specific reference to the appended drawings.

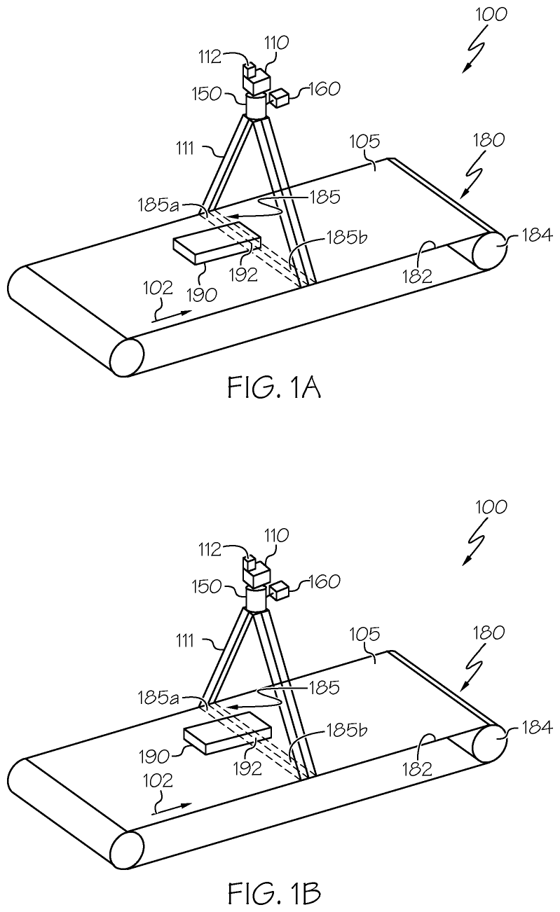

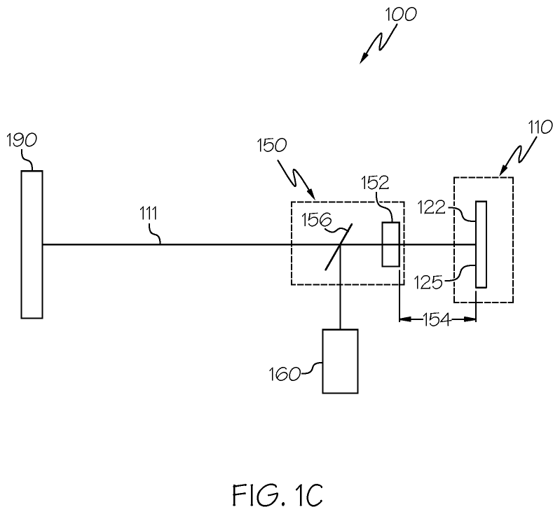

Referring now to FIGS. 1A and 1B, a spectral imaging system 100 is schematically depicted. The spectral imaging system 100 comprises a spectral imager 110, an imaging controller 112, and a support surface 105. The support surface 105 may comprise a translatable component or stationary component, such as a conveyer belt 182, a table, or the like. The support surface 105 and the spectral imager 110 are positioned relative to each other such that an imaging pathway 111 extends between the support surface 105 and the spectral imager 110. For example, the imaging pathway 111 extends across the support surface 105 to form an imaging region 185 at the support surface 105. In operation, the spectral imager 110 may be used to spectrally image one or more specimen samples 190 positioned on the support surface 105, (e.g., a portion (e.g., a first portion 192) of the specimen sample 190 positioned within the imaging region 185 formed at the support surface 105). The specimen sample 190 may comprise any object, for example, one or more food products, raw materials, manufactured goods, or the like. As described in more detail below, the spectral imaging system 100 described herein may be used to spectrally analyze the specimen sample 190.

In some embodiments, the spectral imaging system 100 may include a light generator 160 configured to output light into the imaging pathway 111. The light generator 160 may be a component of the spectral imager 110 or may comprise a component external the spectral imager 110 (as depicted in FIGS. 1A and 1B). The light generator 160 may be configured to output light comprising wavelengths in the infrared range, visible range, ultraviolet light range, or combinations thereof. For example, the light generator 160 may comprise a laser light source, a light emitting diodes (LEDs), or the like. In some embodiments, the spectral imaging system 100 may not include the light generator 160 and instead may use ambient light present in the environment in which the spectral imaging system 100 is located to analyze the specimen sample 190.

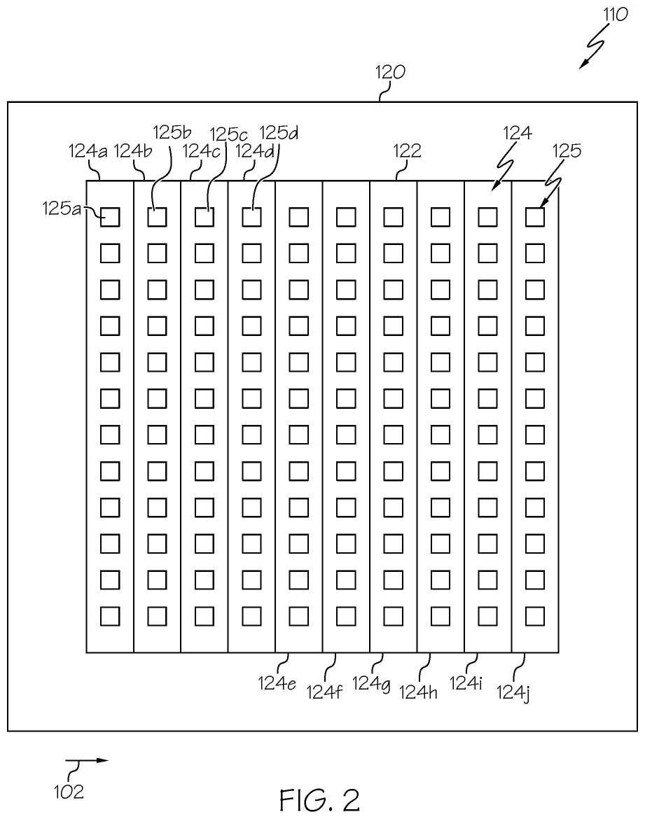

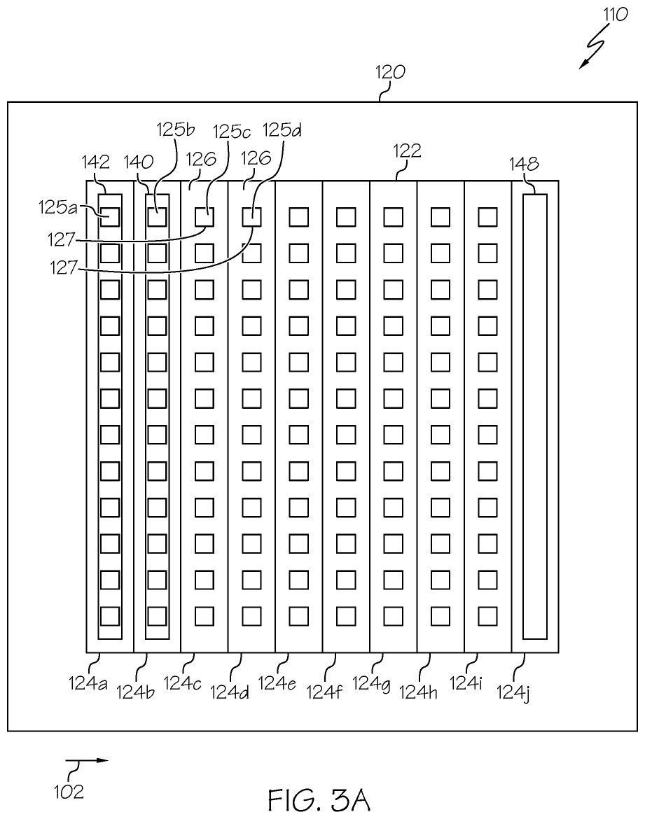

Referring now to FIGS. 1A-1C, the spectral imaging system 100 may further comprise external imaging optics 150 positioned within the imaging pathway 111 between the support surface 105 and the spectral imager 110. The external imaging optics 150 comprise one or more optical elements configured to direct light reflected off the specimen sample 190 onto the spectral imager 110, for example, onto a plurality of imaging pixels 125 (FIG. 2) of the spectral imager 110. Further, the light generator 160 may be optically coupled to the external imaging optics 150 such that light output by the light generator 160 is received by the external imaging optics 150 and directed onto the specimen sample 190. Referring also to FIG. 1C, the external imaging optics 150 may comprise a lens 152 and one or more mirrors, such as a dichroic mirror 156. As depicted in FIG. 1C, the external imaging optics 150 are positioned between the specimen sample 190 and the spectral imager 110. Further, the dichroic mirror 156 is positioned between the specimen sample 190 (which may be positioned on the support surface 105) and the lens 152. Further, the dichroic mirror 156 is configured to direct light output by the light generator 160 onto the specimen sample 190 and allow light reflected off the specimen sample 190 to pass through the dichroic mirror 156 and reach the spectral imager 110. Further, the lens 152 is optically coupled to the plurality of imaging pixels 125, for example, optically coupled to a focal plane array 122 of the spectral imager 110. In some embodiments, the focal plane array 122 and the external imaging optics 150 may be positioned relative to each other such that a focal point 154 of the lens 152 is incident on the focal plane array 122.

Referring again to FIGS. 1A and 1B, the spectral imaging system 100 may comprise a conveyor system 180 including the conveyer belt 182, which may operate as the support surface 105. The conveyer belt 182 is rotatably coupled to one or more conveyer rollers 184 such that rotation of the one or more conveyer rollers 184 translates the conveyer belt 182 in a translation direction 102. Further, the one or more conveyer rollers 184 may be electrically and/or mechanically powered and may rotate to drive the conveyer belt 182 (and the specimen sample 190 positioned thereon) in the translation direction 102, thereby translating the specimen sample 190 and the spectral imager 110 relative to each other. In other embodiments, the support surface 105 comprises a stationary component, such as a table. In these embodiments, the spectral imager 110 may be translatable such that the specimen sample 190 and the spectral imager 110 may be translated relative to each other. For example, the spectral imager 110 may be coupled to a support structure configured to translate the spectral imager 110. Example support structures include a gantry, tripod, or the like, configured to linearly and/or pivotably (e.g., azimuthally) translate the spectral imager 110 relative to the specimen sample 190.

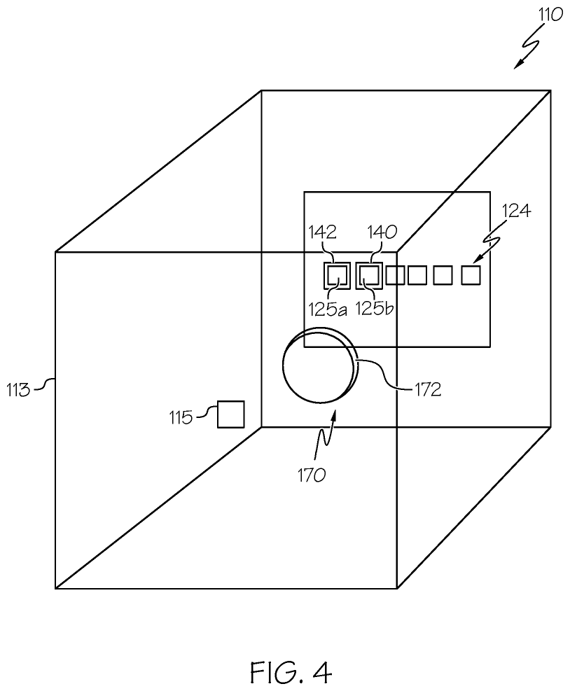

Referring now to FIG. 2, the spectral imager 110 comprises a visual sensing device having the plurality of imaging pixels 125 (e.g., light sensing pixels) including at least a first imaging pixel 125a and a second imaging pixel 125b. In some embodiments, the spectral imager 110 comprises a focal plane array 122 comprising an array of imaging pixels 125. As depicted in FIG. 2, the spectral imager 110 may include a framing camera 120 having the focal plane array 122 that includes the array of imaging pixels 125. As used herein, “framing camera” refers to any digital camera comprising an array of pixels 125 having more than one row of imaging pixels 125 and more than one column of imaging pixels 125 (e.g., a two-dimensional matrix of imaging pixels 125). Example framing cameras 120 include a digital camera, such as a visible wavelength camera or a shortwave camera. In other embodiments, the focal plane array 122 may include just a single row of imaging pixels 125 (as depicted in FIG. 4). The imaging pixels 125 may comprise active pixel sensors, passive pixel sensors, or the like. In some embodiments, each imaging pixel 125 comprises a photodetector (e.g., a photodiode) and a photodetector amplifier (e.g., an active amplifier). Each imaging pixel 125 may additionally comprise a floating diffusion gate, a transfer reset gate, a selection gate, and a source-follower readout transistor. In some embodiments, the framing camera 120 may be a charged coupled device and the imaging pixels 125 may comprise p-doped MOS capacitors.

Referring still to FIG. 2, the focal plane array 122 may comprise a plurality of imaging pixel rows 124 having at least a first imaging pixel row 124a and a second imaging pixel row 124b. Each imaging pixel row 124 comprises two or more imaging pixels 125. For example, the first imaging pixel 125a is positioned within the first imaging pixel row 124a and the second imaging pixel 125b is positioned within the second imaging pixel row 124b. In some embodiments, the focal plane array 122 may comprise about 2-1000 imaging pixel rows 124 and each imaging pixel row 124 may comprise from about 2-1000 imaging pixels 125. Put another way, the focal plane array 122 may comprise about 2-1000 rows of imaging pixels 125 and 2-1000 columns of imaging pixels 125. As one non-limiting example, the focal plane array 122 may comprise a 640×480 array of imaging pixels 125.

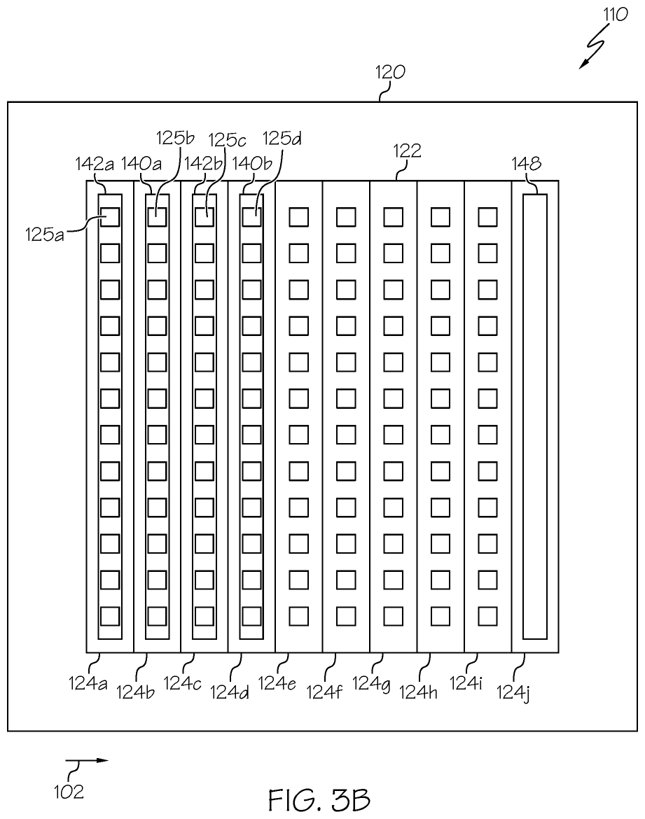

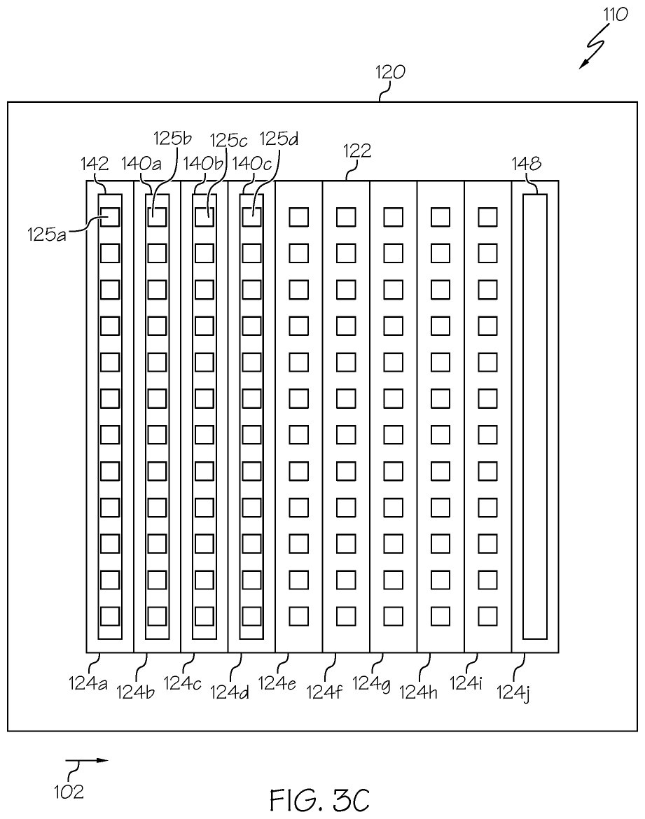

Referring now to FIGS. 3A-3C, the spectral imager 110 further comprises one or more optical elements optically coupled to one or more of the imaging pixels 125, for example, the focal plane array 122 of the framing camera 120. The optical elements may include one or more multivariate optical elements 140, reference filters 142, and/or blocking elements 148 each optically coupled to at least one imaging pixel 125, for example, one or more imaging pixel rows 124. The multivariate optical element 140 is an optical element configured to block or transmit light based on a spectral signature, e.g., block or transmit particular wavelengths of light based on the spectral signature. For example, the multivariate optical element 140 may comprise a thin film interference filter that includes a plurality of films coupled to a substrate (e.g., an optically transmissive substrate). The plurality of films may each be transmissive, reflective, absorptive, or combinations thereof, for different wavelength combinations. Thus, stacking or otherwise coupling the plurality of films together and in some embodiments, positioning the films onto the substrate, provides a multivariate optical element configured to block or transmit light based on a desired spectral signature. Further, the transmissive, reflective, and absorptive properties of each film of the multivariate optical element 140 may be specifically tailored using modeling and regression analysis. While not intending to be limited by theory, a spectral signature is a specific combination of emitted, reflected, or absorbed wavelengths of electromagnetic radiation. As used herein “spectral signature” refers to a unique wavelength combination of light reflected by the specimen sample 190 (e.g., one or more discrete wavelengths and/or discrete wavelength bands), which may be used to identify and/or analyze the specimen sample 190. Further, the unique wavelength combination of the spectral signature may also have a distinct relative intensity relationship such that the specimen sample 190 may be identified by both a specific combination of wavelengths and the relative intensity of each wavelength of the specific combination of wavelengths with respect to the other wavelengths of the specific combination of wavelengths. In operation, the multivariate optical element 140 is configured to permit traversal of light having a wavelength within the spectral signature and prevent traversal of light having wavelengths outside of the spectral signature. Moreover, the relative intensity of the light that traverses the multivariate optical element 140 (e.g., the light within the spectral signature) is not altered by the multivariate optical element 140. Thus, the spectral signature of light that traverses the multivariate optical element 140 comprises both a distinct wavelength combination and a distinct relative intensity combination.

The reference filter 142 comprises an optical filter configured to reduce the intensity of light that traverses the reference filter 142. Thus, light that traverses the reference filter 142 and is received by one or more imaging pixels 125 optically coupled to the reference filter 142 comprises a reduced intensity. The reference filter 142 may comprise a neutral density filter or a linear variable filter. While not intending to be limited by theory, a neutral density filter is configured to equally reduce the intensity of all wavelengths of light traversing the neutral density filter such that the neutral density filter does not spectrally alter the light. In other words, the neutral density filter does not alter the relative intensity at each wavelength of the light received by the spectral imager 110. Thus, light reflected by the specimen sample 190 that irradiates an imaging pixel 125 after traversing the neutral density filter maintains the spectral signature of the specimen sample 190.

Further, while not intending to be limited by theory, a linear variable filter comprises an optical filter having a variable thickness that is configured to non-uniformly reduce the intensity of the light traversing the linear variable filter. Thus, in some embodiments, the linear variable filter may be optically coupled to multiple imaging pixels 125, for example, multiple imaging pixel rows 124 to reduce the intensity of wavelengths of light traversing the linear variable filter differently, depending on the location at which the light is traversing the linear variable filter. For example, the portion of the linear variable filter optically coupled to the first imaging pixel row 124a may be configured to reduce the intensity of light differently than the portion of the linear variable filter optically coupled to the second imaging pixel row 124b. This allows a single linear variable filter to be used instead of multiple neutral density filters, for example, in embodiments in which it is desirable to compare spectral image data to different intensities of reference image data.

In some embodiments, the spectral imager 110 comprises multiple reference filters 142 including both neutral density filters and linear variable filters. Further, in some embodiments, the reference filter 142 may be matched with the multivariate optical element 140. For example, the reference filter 142 may lower the intensity of the light received by the one or more imaging pixels 125 optically coupled to the reference filter 142 such that the maximum intensity of the reference signal is equal to the maximum intensity of the wavelengths within the spectral signature of the corresponding multivariate optical element 140 or within a threshold intensity amount greater than the maximum intensity of the wavelengths of the spectral signature of the corresponding multivariate optical element 140. The corresponding multivariate optical element 140 may be the multivariate optical element 140 positioned adjacent the reference filter 142 in the translation direction 102.

Referring still to FIGS. 3A-3C, the plurality of imaging pixels 125 may comprise one or more unfiltered imaging pixels 127, for example, one or more unfiltered imaging pixel rows 126. The unfiltered imaging pixels 127 are not optically coupled to the multivariate optical element 140 or the reference filter 142. For example, in the embodiments depicted in FIG. 3A, the third imaging pixel row 124c and the fourth imaging pixel row 124d comprise unfiltered imaging pixel rows 126. Further, in the embodiments depicted in FIGS. 3A-3D, the fourth through tenth imaging pixel rows 124e-124j comprise unfiltered imaging pixel rows 126. Moreover, the blocking element 148 may be optically coupled the one or more unfiltered imaging pixels 127, (e.g., disposed over or otherwise optically aligned with the one or more unfiltered imaging pixels 127 to block light from reaching these unfiltered imaging pixels 127). For example, the blocking element 148 may be optically coupled to the tenth imaging pixel row 124j, as depicted in FIGS. 3A-3C. While the blocking element 148 is depicted as optically coupled to the tenth imaging pixel row 124j, it should be understood that this is one example arrangement and in other embodiments one or more blocking elements 148 may be optically coupled to any imaging pixel 125 and imaging pixel row 124.

FIGS. 3A-3C each depict an example spectral imager 110 having different arrangements of reference filter(s) 142 and multivariate optical element(s) 140. In the non-limiting example depicted in FIG. 3A, the reference filter 142 is optically coupled to the first imaging pixel row 124a (and thereby the first imaging pixel 125a), for example, the reference filter 142 may be disposed over or otherwise optically aligned with the first imaging pixel row 124a such that light that traverses the reference filter 142 irradiates the first imaging pixel row 124a. Further, the multivariate optical element 140 is optically coupled to the second imaging pixel row 124b (and thereby the second imaging pixel 125b), for example, the multivariate optical element 140 may be disposed over or otherwise optically aligned with the second imaging pixel row 124b such that light that traverses the multivariate optical element 140 irradiates the second imaging pixel row 124b.

The first imaging pixel row 124a is adjacent the second imaging pixel row 124b such that the imaging pixels 125 optically coupled to the reference filter 142 are positioned adjacent the imaging pixels 125 optically coupled to the multivariate optical element 140. Thus, when a first portion 192 of the specimen sample 190 (FIGS. 1A and 1B) is optically aligned with the first imaging pixel row 124a, light may reflect off the first portion 192 of the specimen sample, traverse the reference filter 142, and irradiate the first imaging pixel row 124a such that the first imaging pixel row 124a outputs a reference signal regarding the first portion of the specimen sample 190. Further, when the first portion 192 of the specimen sample 190 is optically aligned with the second imaging pixel row 124b, for example, by translating the specimen sample 190 in the translation direction 102, light may reflect off the first portion 192 of the specimen sample, traverse the multivariate optical element 140, and irradiate the second imaging pixel row 124b such that the second imaging pixel row 124b outputs a spectral signal regarding the first portion 192 of the specimen sample 190.

In the non-limiting example depicted in FIG. 3B, the spectral imager 110 comprises multivariate optical elements 140 interleaved between the reference filters 142. In particular, a first reference filter 142a is optically coupled to the first imaging pixel row 124a, a first multivariate optical element 140a is optically coupled to the second imaging pixel row 124b, a second reference filter 142b is optically coupled to the third imaging pixel row 124c, and a second multivariate optical element 140b is optically coupled to a fourth imaging pixel row 142d. In some embodiments, the first reference filter 142a may be matched with the first multivariate optical element 140a and the second reference filter 142b may be matched with the second multivariate optical element 140b. For example, the first reference filter 142a may lower the intensity of the light received by the first imaging pixel row 124a such that the maximum intensity of the reference signal output by the first imaging pixel row 124a is equal or within a threshold intensity amount of the maximum intensity of the wavelengths within the spectral signature of the first multivariate optical element 140a and the second reference filter 142b may lower the intensity of the light received by the third imaging pixel row 124c such that the maximum intensity of the reference signal output by the third imaging pixel row 124c is equal or within a threshold intensity amount of the maximum intensity of the wavelengths within the spectral signature of the second multivariate optical element 140b.

In some embodiments, the first reference filter 142a and the second reference filter 140d may reduce light intensity by different amounts and the first multivariate optical element 140a and the second multivariate optical element 140b may comprise different spectral signatures. Further, in some embodiments, the second reference filter 142b and the second multivariate optical element 140b may be duplicates of the first reference filter 142a and first multivariate optical element 140a such that the specimen sample 190 may be analyzed multiple times in one pass of the spectral imager 110.

In the non-limiting example depicted in FIG. 3C, the spectral imager 110 comprises a reference filter 142 optically coupled to the first imaging pixel row 124a and multiple multivariate optical elements 140a, 14b, 140c optically coupled to second, third and fourth imaging pixel rows 124b-124d, respectively. In particular, the first multivariate optical element 140a is optically coupled to the second imaging pixel row 124b, the second multivariate optical element 140b is optically coupled to the third imaging pixel row 124c, and the third multivariate optical element 140c is optically coupled to the fourth imaging pixel row 124d. In this embodiment, each multivariate optical element 140a, 140b, 140c may each comprise different spectral signatures and the first reference filter 142a may facilitate the generation of reference signals that may be compared to the spectral signals generated using the second, third, and fourth imaging pixel rows 124b, 124c, 124d. For example, the maximum intensity of the reference signal may be within a threshold intensity amount of the spectral signature of the first, second, and third multivariate optical elements 140a, 140b, 140c.

Referring now to FIG. 4, the spectral imager 110 may further comprise a housing 113 and an aperture 115 located on the housing 113. The aperture 115 provides a location for light to enter the housing 113. In embodiments comprising the housing 113, the plurality of imaging pixels 125 may be housed within the housing 113 such that light traverses the aperture 115 before irradiating the plurality of imaging pixels 125. Further, the one or more multivariate optical elements 140 and the one or more reference filters 142 may be housed within the housing 113. For example, the reference filter 142 may be optically coupled to the first imaging pixel 125a and the multivariate optical element 140 may be optically coupled to the second imaging pixel 125b.

As depicted in FIG. 4, the spectral imager 110 may further comprise internal imaging optics 170 positioned within the housing 113, between and optically coupled to the aperture 115 and the plurality of imaging pixels 125. The internal imaging optics 170 comprise a translatable optical component 172 configured to selectively direct light from the aperture 115 onto one or more specific sets of imaging pixels 125, such as specific imaging pixels 125 or specific imaging pixel rows 124. While a single imaging pixel row 124 is depicted in FIG. 4, it should be understood that embodiments of the spectral imager 110 comprising the focal plane array 122 may also include and utilize the internal imaging optics 170 having the translatable optical component 172. In one example operation, the translatable optical component 172 may first direct light from the aperture 115 (e.g., light reflected off the specimen sample 190) onto the first imaging pixel 125a such that light traverses the reference filter 142 and irradiates the first imaging pixel 125a. Next, the translatable optical component may translate to optically align the aperture 115 with the second imaging pixel 125b such that light traverses the multivariate optical element 140 and irradiates the second imaging pixel 125b. The translatable optical component 172 allows the spectral imager 110 to generate reference signals and spectral signals regarding the specimen sample 190 (e.g., the first portion 192 of the specimen sample 190) without translating the spectral imager 110 and the specimen sample 190 relative to one another.

Referring now to FIGS. 1A-4, the imaging controller 112 is communicatively coupled to the plurality of imaging pixels 125, for example, the focal plane array 122 of the framing camera 120. The imaging controller 112 comprises one or more processors and one or more memory modules and is configured to generate image data based on signals output by the plurality of imaging pixels 125 and received by the imaging controller 112. For example, the imaging controller 112 may generate reference image data based on reference signals output by the imaging pixels 125 optically coupled to the reference filter(s) 142 and the imaging controller 112 may generate spectral image data based on spectral signals output by the imaging pixels 125 optically coupled to the multivariate optical element(s) 140. Further, the imaging controller 112 may comprise a computing component of the spectral imager 110 or a computing component that is separate from the spectral imager 110, e.g., an external computing device communicatively coupled to the imaging controller 112.

In operation, the imaging controller 112 is configured to generate image data based on signals output by a first subset of the plurality of imaging pixels 125 and not generate image data based on signals output by a second subset of the plurality of imaging pixels 125. For example, the first subset of the plurality of imaging pixels 125 may include the imaging pixels 125 that are optically coupled to the reference filter 142 and the multivariate optical element 140 and the second subset of the plurality of imaging pixels 125 may comprise the unfiltered imaging pixels 127. In the example embodiment depicted in FIG. 3A, the first subset of the plurality of imaging pixels 125 includes the first imaging pixel row 124a, which is optically coupled to the reference filter 142, and the second imaging pixel row 124b, which is optically coupled to the multivariate optical element 140. In this embodiment, second subset of the plurality of imaging pixels 125 includes the remaining, unfiltered imaging pixels 127. In the example embodiments depicted in FIGS. 3B and 3C, the first subset of the plurality of imaging pixels 125 includes the first, second, third, and fourth imaging pixel rows 124a-124d, which are each optically coupled to a reference filter 142 or a multivariate optical element 140. In this embodiment, the second subset of the plurality of imaging pixels 125 includes the remaining, unfiltered imaging pixels 127.

Not generating image data based on signals output by the second subset of the plurality of imaging pixels 125 (e.g., windowing the second subset of the plurality of imaging pixels 125) allows the imaging controller 112 to generate image data at increased processing speeds (e.g., an increased acquisition frame rate). Further, the acquisition frame rate of the spectral imager 110 increases in inverse proportion with the decrease in pixel volume (e.g., a decrease in the number of imaging pixels 125). This allows the framing camera 120 to operate with the acquisition frame rate of a line scan camera without the increased cost of a line scan camera. As a non-limiting example, a spectral imager 110 having and a focal plane array 122 comprising a 640×480 array of imaging pixels 125 may have an acquisition frame rate of about 100 frames per second (fps). In this embodiment, windowing the focal plane array 122 to a 640×2 array of imaging pixels 125, the frame rate increases up to about 24000 fps (e.g. increases by about 240 times because 480 divided by 2 is 240). However, in some embodiments, the increased acquisition frame rate may be reduced due to overhead processing losses caused by the spectral imager 110 and the imaging controller 112.

Further, in operation, the relative translation speed between the spectral imager 110 and the specimen sample 190 may be configured to match the acquisition frame rate of the imaging controller 112, which may maximize the speed of data generation of each embodiment of the spectral imaging system 100 described herein. Further, when the acquisition frame rate of the imaging controller 112 is high, such as when the first subset of the plurality of imaging pixels 125 includes only the first and second imaging pixel rows 124a, 124b, as depicted in FIG. 3A, the relative translation speed between the spectral imager 110 and the specimen sample 190 may be a first translation speed. When the acquisition frame rate of the imaging controller 112 is lower, such as when the first subset of the plurality of imaging pixels 125 includes the first through fourth imaging pixel rows 124a-124d, as depicted in FIGS. 3B and 3C, the relative translation speed between the spectral imager 110 and the specimen sample 190 may be a second translation speed that is slower than the first translation speed.

Referring still to FIGS. 1A-4, a method of analyzing the specimen sample 190 using the spectral imaging system 100 is contemplated. While the method is described below in a particular order, it should be understood that other orders are contemplated. The method first includes generating a reference signal regarding a first portion 192 of the specimen sample 190 using the spectral imager 110. To generate the reference signal, the first portion 192 is optically aligned with the first imaging pixel 125a, which may be located in the first imaging pixel row 124a and is optically coupled to the reference filter 142. For example, by positioning the first portion 192 of the specimen sample 190 in a first portion 185a of the imaging region 185 (as depicted in FIG. 1A), the first portion 192 of the specimen sample 190 may be optically aligned with the reference filter 142 and the first imaging pixel 125a. Light may traverse the reference filter 142 then irradiate the first imaging pixel 125a such that the first imaging pixel 125a outputs a reference signal regarding the first portion 192 of the specimen sample 190. The light received by the first imaging pixel 125a comprises light reflected off the first portion 192 of the specimen sample 190 and, in some embodiments, light first output by the light generator 160. The reference signal may be received by the imaging controller 112 which generates reference image data regarding the first portion 192 of the specimen sample 190 based on the reference signal.

Next, the method comprises optically aligning the first portion 192 of the specimen sample 190 with the second imaging pixel 125b (for example, the second imaging pixel row 124b), such that light traverses the multivariate optical element 140 before irradiating the second imaging pixel 125b. For example, positioning the first portion 192 of the specimen sample 190 in a second portion 185b of the imaging region 185 (as depicted in FIG. 1B) may optically align the first portion 192 of the specimen sample 190 with the multivariate optical element 140 and the second imaging pixel 125d. In some embodiments, optically aligning the first portion 192 of the specimen sample 190 with the second imaging pixel 125b comprises translating the second imaging pixel 125b and the specimen sample 190 relative to each other, for example, by translating the specimen sample 190 in the translation direction 102 using the conveyer belt 182, translating the spectral imager 110 (for example, in a direction opposite the translation direction 102), or both. Further, in embodiments of the spectral imager 110 comprising internal imaging optics 170 that include the translatable optical component 172, optically aligning the first portion 192 of the specimen sample 190 with the second imaging pixel 125b may comprise translating the translatable optical component 172 of the internal imaging optics 170 to direct light onto the second imaging pixel 125b.

Once the first portion 192 of the specimen sample 190 is optically aligned with the second imaging pixel 125b, the method further comprises generating a spectral signal using the second imaging pixel 125b. In particular, the spectral signal is generated upon irradiation of light onto the second imaging pixel 125b. Light may traverse the multivariate optical element 140 then irradiate the second imaging pixel 126a such that the first imaging pixel 125a outputs a spectral signal regarding the first portion 192 of the specimen sample 190. The light received by the second imaging pixel 125b comprises light reflected off the first portion 192 of the specimen sample 190 and, in some embodiments, light first output by the light generator 160. The spectral signal may be received by the imaging controller 112 which generates spectral image data regarding the first portion 192 of the specimen sample 190 based on the spectral signal.

Referring still to FIGS. 1A-4, the method further comprises comparing the reference image data and the spectral image data using the imaging controller 112 and determining a target spectral signature of first portion 192 of the specimen sample 190 based on the comparison between the reference image data and the spectral image data. In some embodiments, the method further includes comparing the target spectral signature of the first portion 192 of the specimen sample 190 with a baseline spectral signature of the first portion 192 of the specimen sample 190. The baseline spectral signature may be stored in the one or more memory modules of the imaging controller 112. The baseline spectral signal comprises a desired spectral signature of the specimen sample 190. For example, in an embodiment in which the specimen sample 190 comprises a food product, the baseline spectral signature may comprise the spectral sample of a ripe version of the food product. Comparing the measured target spectral signature with the baseline spectral signature allows a user to determine the quality of the specimen sample 190. Moreover, the above described method steps may be repeated for other portions of the specimen sample 190, allowing the imaging controller 112 to generate image data regarding the complete specimen sample 190 and, in some embodiments, multiple specimen samples 190.

In view of the foregoing description, it should be understood that a spectral imaging system includes a spectral imager having a reference filter and a multivariate optical filter each optically coupled to imaging pixels such that the imaging pixels may output a reference signal or a spectral signal based on light reflected off a specimen sample. An imaging controller generates image data (e.g., reference image data and spectral image data) regarding the specimen sample based on the signals output by the plurality of imaging pixels to localize a target spectral signature of the specimen sample. The spectral imaging system described herein operates at the high processing speeds of a line scan camera without the increased cost of a line scan cameras. Moreover, the spectral imaging system described herein may perform hyper-spectral imaging with less complexity and at a lower cost than previous imaging systems.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

It is noted that the term “substantially” may be utilized herein to represent the inherent degree of uncertainty that may be attributed to any quantitative comparison, value, measurement, or other representation. This term is also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed:

1. A spectral imaging system comprising:
a focal plane array, wherein:
the focal plane array comprises a plurality of imaging pixel rows;
each imaging pixel row of the plurality of imaging pixel rows comprises two or more individual imaging pixels; and
the plurality of imaging pixel rows comprise a first imaging pixel row and a second imaging pixel row;
a reference filter optically coupled to the first imaging pixel row of the focal plane array; and
a multivariate optical element optically coupled to the second imaging pixel row of the focal plane array.

2. The spectral imaging system of claim 1, further comprising imaging optics comprising at least one lens optically coupled to the focal plane array, wherein the focal plane array and the imaging optics are positioned relative each other such that a focal point of the at least one lens is incident on the focal plane array.

3. The spectral imaging system of claim 1, further comprising an imaging controller comprising one or more processors and one or more memory modules, wherein:
the imaging controller is communicatively coupled to the focal plane array and configured to process signals output by the focal plane array and generate image data based signals output by a subset of the plurality of imaging pixel rows of the focal plane array; and
the subset of the plurality of imaging pixel rows includes the first pixel row and the second pixel row.

4. The spectral imaging system of claim 3, wherein:
the plurality of imaging pixel rows comprise Cl unfiltered imaging pixel row that is not optically coupled to the multivariate optical element or the reference filter; and
the subset of the plurality of imaging pixel rows does not include the unfiltered imaging pixel row.

5. The spectral imaging system of claim 1, wherein the multivariate optical element is configured to permit traversal of light comprising one or more wavelengths of a spectral signature through the multivariate optical element and prevent traversal of light comprising one or more wavelengths outside of the spectral signature through the multivariate optical element.

6. The spectral imaging system of claim 1, wherein the multivariate optical element comprises a first multivariate optical element and the spectral imaging system further comprises a second multivariate optical element optically coupled to a third imaging pixel row of the plurality of imaging pixel rows, wherein the second imaging pixel row is positioned between the first imaging pixel row and the third imaging pixel row.

7. The spectral imaging system of claim 1, wherein the reference filter comprises a neutral density filter configured to reduce the intensity of light received by the first imaging pixel row of the plurality of imaging pixel rows.

8. The spectral imaging system of claim 1, wherein the multivariate optical element comprises a first multivariate optical element, the reference filter comprises a first reference filter, and the spectral imaging system further comprises:
a second reference filter optically coupled to a third imaging pixel row and;
a second multivariate optical element optically coupled to a fourth imaging pixel row of the plurality of imaging pixel rows, wherein:
the second imaging pixel row is positioned between the first imaging pixel row and the third imaging pixel row; and
the third imaging pixel row is positioned between the second imaging pixel row and the fourth imaging pixel row.

9. The spectral imaging system of claim 1, wherein the reference filter comprises a linear variable filter.

10. The spectral imaging system of claim 1, further comprising a conveyer system having a conveyer belt rotatably coupled to one or more conveyer rollers, wherein the conveyer belt and the focal plane array are positioned such that an imaging pathway extends between the conveyer belt and the focal plane array.

11. A method comprising:
generating a reference signal regarding a first portion of the specimen sample using a spectral imaging system, the spectral imaging system comprising:
a plurality of imaging pixels comprising a first imaging pixel and a second imaging pixel;
a reference filter optically coupled to the first imaging pixel; and
a multivariate optical element optically coupled to the second imaging pixel;
wherein the first portion of the specimen sample is optically aligned with the first imaging pixel such that light traverses the reference filter before irradiating the first imaging pixel, thereby generating the reference signal;
optically aligning the first portion of the specimen sample with the second imaging pixel such that light traverses the multivariate optical element before irradiating the second imaging pixel; and
generating a spectral signal upon irradiation of light onto the second imaging pixel.

12. The method of claim 11, further comprising:
receiving the reference signal and the spectral signal at an imaging controller communicatively coupled to the first imaging pixel and the second imaging pixel;
generating, using the imaging controller, reference image data regarding the first portion of the specimen sample based on the reference signal and spectral image data regarding the first portion of the specimen sample based on the spectral signal;
comparing the reference image data and the spectral image data; and
determining a target spectral signature of first portion of the specimen sample based on the comparison between the reference image data and the spectral image data.

13. The method of claim 12, further comprising comparing the target spectral signature of the first portion of the specimen sample with a baseline spectral signature of the first portion of the specimen sample.

14. The method of claim 11, wherein the spectral imaging system further comprises:
a focal plane array, wherein:
the focal plane array comprises a plurality of imaging pixel rows;
each imaging pixel row of the plurality of imaging pixel rows comprises two or more individual imaging pixels; and
the plurality of imaging pixel rows comprise a first imaging pixel row that includes the first imaging pixel and a second imaging pixel row that includes the second imaging pixel, wherein:
the reference filter is optically coupled to the first imaging pixel row of the focal plane array; and
the multivariate optical element is optically coupled to the second imaging pixel row of the focal plane array.

15. The method of claim 14, wherein optically aligning the first portion of the specimen sample with the second imaging pixel comprises translating the focal plane array and the specimen sample relative to each other.

16. The method of claim 14, wherein the spectral imaging system further comprises:
an aperture; and
imaging optics positioned between and optically coupled to the aperture and the plurality of imaging pixels, wherein the imaging optics are configured to direct light from the aperture onto one or more of the plurality of imaging pixels, wherein:
the reference filter is positioned between the imaging optics and the first imaging pixel; and
the multivariate optical element is positioned between the imaging optics and the second imaging pixel.

17. The method of claim 16, wherein the imaging optics comprise a translatable optical component and optically aligning the first portion of the specimen sample with the second imaging pixel comprises translating the translatable optical component of the imaging optics to direct light onto the second imaging pixel.

18. A spectral imaging system comprising:
an aperture;
a plurality of imaging pixels comprising a first imaging pixel and a second imaging pixel;
imaging optics positioned between and optically coupled to the aperture and the plurality of imaging pixels, wherein the imaging optics are configured to direct light from the aperture onto one or more of the plurality of imaging pixels;
a reference filter optically coupled to the first imaging pixel and positioned between the imaging optics and the first imaging pixel; and
a multivariate optical element optically coupled to the second imaging pixel and positioned between the imaging optics and the second imaging pixel.

19. The spectral imaging system of claim 18, further comprising a housing wherein:
the aperture is located on the housing; and
the plurality of imaging pixels, the imaging optics, the reference filter, and the multivariate optical element are each housed within the housing.

20. The spectral imaging system of claim 18, wherein the imaging optics comprise a translatable optical component configured to selectively direct light onto the first imaging pixel and the second imaging pixel.
